(19) United States
(12) Patent Application Publication
(10) Pub. No.: US 2018/0357569 A1
(43) Pub. Date: Dec. 13, 2018

(54) MULTI-MODAL DECLARATIVE CLASSIFICATION BASED ON UHRS, CLICK SIGNALS AND INTERPRETED DATA IN SEMANTIC CONVERSATIONAL UNDERSTANDING

(71) Applicant: Element Data, Inc., Seattle, WA (US)

(72) Inventors: Viswanath Vadlamani, Sammamish, WA (US); Phani Vaddadi, Bellevue, WA (US); Charles F. L. Davis, Elk Grove, CA (US)

(21) Appl. No.: 16/001,757

(22) Filed: Jun. 6, 2018

Related U.S. Application Data
(60) Provisional application No. 62/516,790, filed on Jun. 8, 2017.

(51) Int. Cl. G06N 99/00; G06F 17/28

(52) U.S. Cl. CPC G06N 99/005; G06F 17/28

(57) ABSTRACT

Examples are presented for a classification system that utilizes multiple classification models to adapt to any desired set of raw data to be classified. The classification system may include multiple classification models stored in a model repository. A truth set of the raw data may be used to evaluate the fitness of each of the stored classification models. The models may be scored and ranked to determine which is the most appropriate to use for real time classification of the raw data. The optimal classification model may be used in a classification engine to classify the raw data in real time. This generates a classified output that may be interacted with by a user. A user interface may be used to permit feedback of the classified output to be generated. This feedback may then be transmitted to the offline system and recorded to further improve the classification models.

### CROSS REFERENCES TO RELATED APPLICATIONS

This application claims the benefit of U.S. Provisional Application 62/516,790, filed Jun. 8, 2017, and titled “MULTI-MODAL DECLARATIVE CLASSIFICATION BASED ON UHRS, CLICK SIGNALS AND INTERPRETED DATA IN SEMANTIC CONVERSATIONAL UNDERSTANDING,” the disclosure of which is hereby incorporated herein in its entirety and for all purposes.

### TECHNICAL FIELD

The subject matter disclosed herein generally relates to processing data in machine learning (ML) classification engines. In some example embodiments, the present disclosures relate to methods and systems for a multi-modal declarative classification based on the Universal Human Relevance System (UHRS), click signals and interpreted data in semantic conversational understanding.

### BACKGROUND

The advance of technology to ingest and classify the millions of digital human communications should provide new functionality and improved speed. Typical classification engines used to classify subsets of the never-ending stream of digital human communications tend to require weeks of prior corpus training, and may be too slow to dynamically adapt to the ever changing trends in social media and news in general. It is desirable to generate improved classification techniques to be more flexible and dynamic in the face of an ever-changing environment.

### BRIEF SUMMARY

Aspects of the present disclosure are presented for a classification system for classifying documents in real time using natural language processing. The classification system may include: at least one processor and at least one memory communicatively coupled to the processor. The at least one memory may store classification modules comprising: a tenant and domain judgement factory configured to classify a subset of documents from a present set of documents to be classified, and generate a golden set of documents that represents an accurate classification of the subset of documents. The at least one memory may also store a model repository configured to store a plurality of classification models, wherein each classification model was generated to originally classify a different set of documents than the present set of documents to be classified. The at least one memory may also store a metrics and evaluation system configured to evaluate a fitness level of each of the plurality of classification models to the present set of documents to be classified, by classifying the golden set using said each classification model and determining which classification model generates the most accurate classification of the golden set. The at least one memory may also store a classification engine configured to perform, in real time, classification on the remaining present set of documents to be classified, using the classification model that generated the most accurate classification of the golden set.

In some embodiments of the classification system, the classification engine is further configured to produce a classified output of the remaining present set of documents comprising judgements about the classification of each of the documents.

In some embodiments, the classification system further comprises a user interface configured to cause display of the classified output and enable user interaction with the classified output.

In some embodiments of the classification system, the user interface is further configured to enable examination of the accuracy of the classified output by a user.

In some embodiments of the classification system, the user interface is further configured to: produce behavior signals with the classified output by recording user interactions with the classified output; and transmit the behavior signals to the metrics and evaluation system.

In some embodiments of the classification system, the metrics and evaluation system is further configured to adjust the most accurate classification model using the received behavior signals to produce an even more accurate classification model for classifying the present documents to be classified.

In some embodiments of the classification system, the metrics and evaluation system evaluates the fitness of each of the plurality of classification models by: calculating at least one of precision, recall, and F1 statistics to evaluate how well each classification model has classified the golden set; ranking the at least one of precision, recall, and F1 statistics; and selecting the best ranked classification model to be used to classify the remaining set of documents in the classification engine.

In some embodiments of the classification system, the metrics and evaluation system is further configured to evaluate the fitness level of a combination of two or more classification models stored in the model repository to the present set of documents to be classified, by classifying the golden set using the combination of two or more classification models and determining the combination of the two or more classification models generates the most accurate classification of the golden set.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows an example functional block diagram of a classification engine or platform of the present disclosure, according to some embodiments.

FIG. 3 shows an example subscription configuration file that may be accessed by the classification engine, according to some embodiments.

FIG. 4 shows an illustration providing further details into one example of the metrics and evaluation system, according to some embodiments.

FIG. 5 shows an illustration providing further details into one example of the classification engine, according to some embodiments.

FIG. 6 provides an example methodology of a classification engine of the present disclosure for processing classification queries in real time or near real time, as well as processing new classification queries while live streaming human communications, and providing the results to a subscriber, according to some embodiments.

FIG. 7 is a block diagram illustrating components of a machine, according to some example embodiments, able to read instructions from a machine-readable medium and perform any one or more of the methodologies discussed herein.

### DETAILED DESCRIPTION

A wide range of classification methods are currently available in the industry as part of machine learning (ML) toolkits. They currently provide basic functionality that can be used for data sets that are pre-defined. The tuning of these classifiers depend on parameters that tend to require code changes. Current classifiers can identify set membership of data for multiple classes. These classifiers need to be customized and extended through custom coding to address specific classes of data. The feature selection for these classifiers also typically needs to be done through plugins or extensions. It would be desirable to more efficiently conduct classification on a wide range of categories using more automated methods that rely less on manual human configurations.

Example methods, apparatuses, and systems (e.g., machines) are presented for a classification system that utilizes multiple classification models to adapt to any desired set of raw data to be classified. The classification system includes an offline system portion, an online system portion, and a feedback mechanism, that together creates a dynamic solution to quickly and more efficiently classify varied sets of raw data.

In the offline system, according to some embodiments, multiple classification models are stored in a model repository. A truth set of the raw data, herein referred to as a “golden set,” may be used to evaluate the fitness of each of the stored classification models. The models are scored and ranked to determine which may be the most appropriate to use for real time classification of the raw data.

In the online system, according to some embodiments, the optimal classification model is used in a classification engine to classify the raw data in real time. This generates a classified output that may be interacted with by a user, such as a client requesting the classification of the raw data.

The classification system of the present disclosures may also include a user interface to permit feedback of the classified output to be generated. This feedback may then be transmitted to the offline system and recorded to further improve the classification models.

In this way, the classification system allows for a comprehensive solution, utilizing multiple techniques to create an optimized classification solution to any set of raw data.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

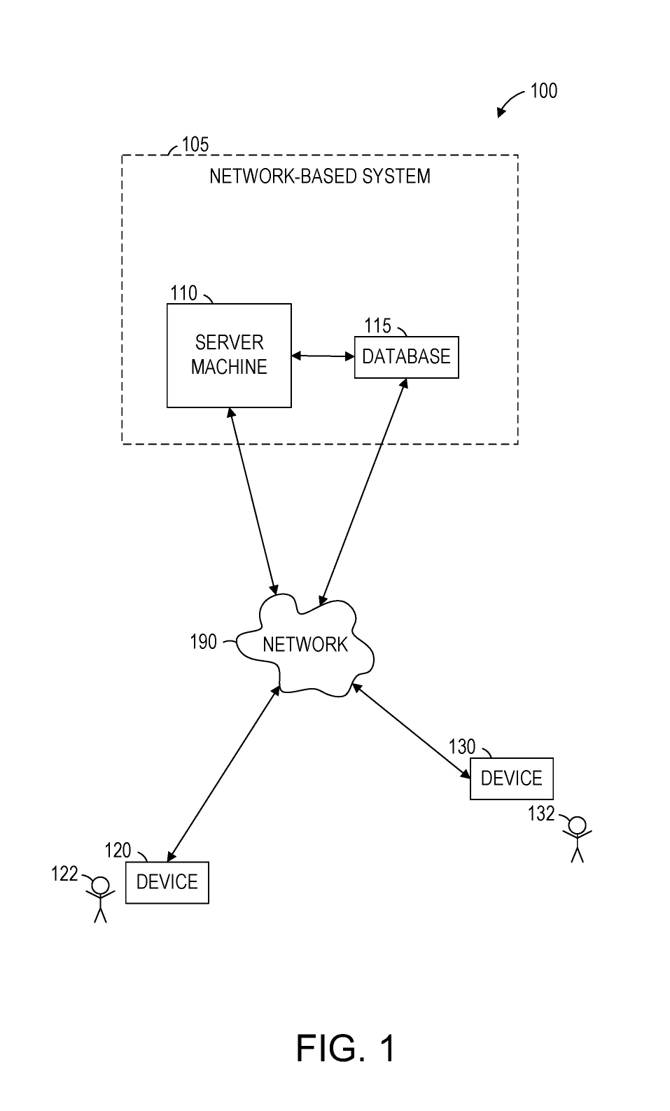

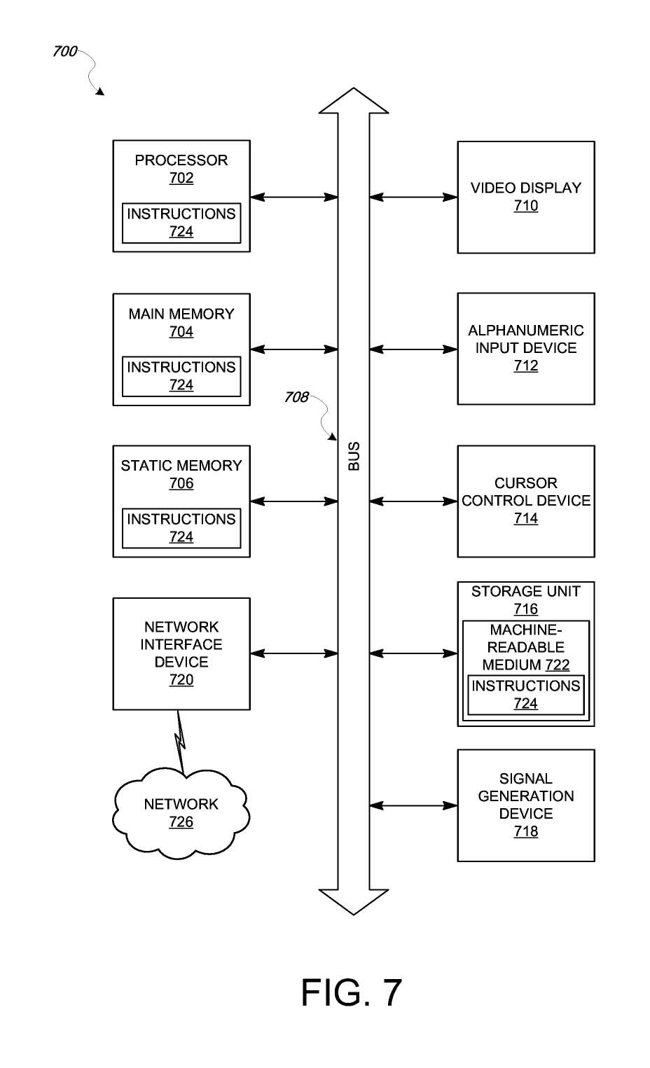

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). The server machine 110, the first device 120, and the second device 130 may each be implemented in a computer system, in whole or in part, as described below with respect to FIG. 7. The network-based system 105 may be an example of a classification platform or engine according to the descriptions herein. The server machine 110 and the database 115 may be components of the auction engine configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users, subscribers, or customers interfacing with the network-based system 105 to utilize the classification methods according to the present disclosure. The users 122 and 132 may interface with the network-based system 105 through the devices 120 and 130, respectively.

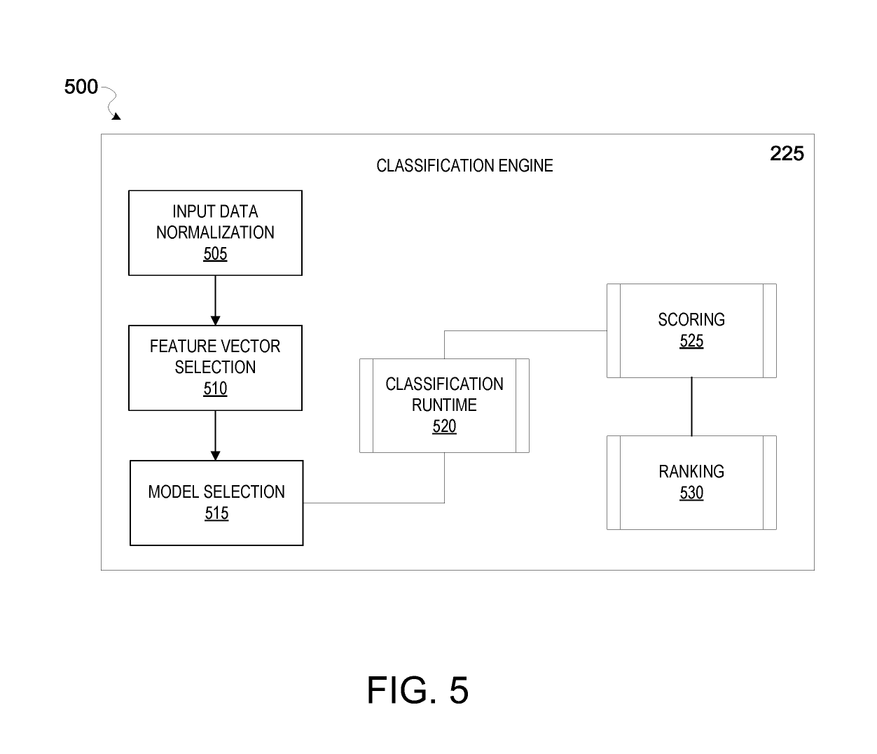

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 5. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

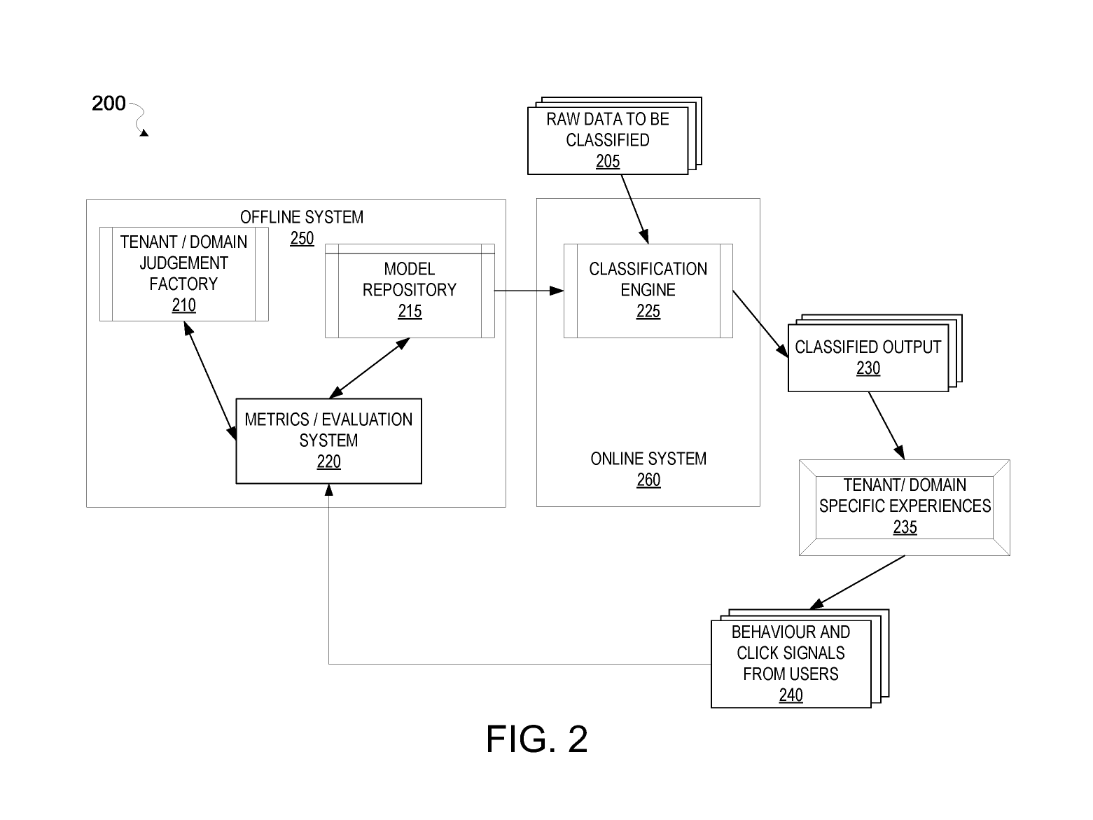

Referring to FIG. 2, illustration 200 shows a classification system of the present disclosures in more detail, according to some embodiments. Here, the classification system includes an offline system 250 and an online system 260, both of which may be portions of the network-based system 105 (see FIG. 1). The offline system includes system components that may perform functions that do not need to be performed in real time, while the online system may perform functions for handling classification of a desired set of raw data in real time. Illustration 200 also shows portions of the system interaction that occur at the user level, such as in user devices 120 or 130 (see FIG. 1).

The objective of the classification system overall is to ingest the raw data 205 and classify each document or individual item of raw data 205 into one or more categories that accurately describes the data, such as describing the general subject matter of each document in the raw data 205. To do this, the classification system of the present disclosure utilizes natural language processing models that analyze the raw data 205 and perform complex operations on the text to determine a judgement about the data. In general, a number of these natural language processing techniques are available and known to those of skill in the art. Unlike typical engines that often need to be individually configuration driven to cater to a specific set of raw data, the classification system of the present disclosures allows for multiple classification models to be utilized and configured to classify raw data sets that can pertain to multiple taxonomies.

Still referring to FIG. 2, the offline system 250 includes a tenant/domain judgement factory 210, a model repository 215, and a metric/evaluation system 220, according to some embodiments. The model repository 215 includes multiple classification models that have already been computed and optimized to conduct classification on at least one set of raw data. For example, one model stored in the model repository may have been previously computed to classify journal articles about biology, while another model was configured to classify live communications (e.g., Tweets) that discuss travel plans. Other models may be stored that are originally configured to classify other Tweets in subjects tangentially related to desire to travel or travel plans, as another example. Any number of models may be stored, providing easy access, storage, and retrieval for use in the overall classification system of the present disclosures.

The tenant and domain judgement factory 210 may include a comprehensive Universal Human Relevance System (UHRS) and may be used for the purpose of judging a subset of the raw data 205 to be classified. In some embodiments, other systems may be used for collecting the data to make judgements and determine a truth set. It is here that a set of true classifications about the subset of raw data is made, that can then be used to compare and evaluate the fitness of classification models for use in real time on the rest of the raw data 205. This truth set may be referred to as the “golden set” of judgements. In some cases, the golden set is created with the help of human manual inputs, such as through human annotations scoring the data. In some embodiments, the judgement factory 210 may classify the golden set into multiple classes, meaning each document in the golden set may belong to more than one class, and/or a first document in the golden set may be classified into a first class but not a second class, while a second document in the golden set may be classified into a second class but not the first class (i.e., their classifications are mutually exclusive). The golden set can therefore include documents belonging to multiple classes, which will represent the expectation that the raw data 205 will also include documents that belong to classes that are mutually exclusive of each other.

In some embodiments, a transactional dataset is also used to inform how the golden set is generated. For example, as the golden set represents a truth set of how the raw data should be classified at a particular point in time, these answers may already be supplied and can be obtained through previous transactional datasets.

The metrics evaluation system 220 may be configured to evaluate any classification model stored in the model repository 215 for its fitness in relation to the golden set formed in the tenant and domain judgment factory 210, given that the models stored in the model repository 215 were originally generated not necessarily to cater to the content in the golden set. For example, the golden set may contain all the correct classifications for each document in the golden set, and a classification model in the model repository 215 may be tested in the metrics evaluation system 220 using the golden set, though the classification model from the model repository 215 was generated originally to classify a different set of documents related to different subject matter. The outputs of the tested model when attempting to classify all the documents in the golden set may be compared against the known correct answers. The metrics evaluation system 220 may calculate the precision, recall, F1 statistics and other metrics to evaluate how well a model has classified the golden set. The metrics evaluation system may calculate these fitness scores for multiple models in the repository 215 to determine which model(s) may be best used to classify the remaining raw data 205 in real time. The metrics evaluation system may score each of these models based on one or more of these metrics, then rank the models, and selects one or more of the best models from the repository. In some embodiments, the scoring, ranking, and thresholds for determining the fitness of the models are configuration driven. The labels and specific classes are all configuration driven because they are abstracted out as ID's, according to some embodiments. In this way, it is not necessary to build a model every time a new set of raw data needs to be classified, unlike in conventional methods where a unique model often needs to be built from scratch to handle the particularized needs of a client.

The following is an example configuration used to determine scoring, ranking and thresholding regarding the fitness of a model, according to some embodiments:

```
  “travel”: {
“ProspectClassifier”: {
    “vector”: {
        “name”: “vect”,
        “parameters”: {
            “ngram_range”: [1, 1]
        }
    },
    “transformer”: {
        “name”: “tfidf”,
        “parameters”: {
            “use_idf”: “True”,
            “sublinear_tf”: “True”
        }
    },
    “classifier”: {
        “name”: “clf”,
        “parameters”: {
            “C” : 0.7
        }
    }
},
“PurchaseIntentClassifier”: {
    “vector”: {
        “name”: “vect”,
        “parameters”: {
            “ngram_range”: [1, 3]
        }
    },
    “transformer”: {
        “name”: “tfidf”,
        “parameters”: {
            “use_idf”: “True”,
            “sublinear_tf”: “True”
        }
    },
    “classifier”: {
        “name”: “clf”,
        “parameters”: {
            “C” : 1.28
        }
    }
},
“PurchaseTimeClassifier”: {
    “vector”: {
        “name”: “vect”,
        “parameters”: {
            “ngram_range”: [1, 3]
        }
    },
    “transformer”: {
        “name”: “tfidf”,
        “parameters”: {
            “use_idf”: “True”,
            “sublinear_tf”: “True”
        }
    },
    “classifier”: {
        “name”: “clf”,
        “parameters”: {
            “C” : 1.14
        }
    }
},
“IndustryClassifier”: {
    “vector”: {
        “name”: “vectorizer”,
        “parameters”: {
            “ngram_range”: [1, 2]
        }
    },
    “transformer”: {
        “name”: “tfidf”,
        “parameters”: {
            “use_idf”: “True”,
            “sublinear_tf”: “True”
        }
    },
    “classifier”: {
        “name”: “clf”,
        “parameters”: {
            “C” : 1.0,
            “cache_size”: 200,
            “class_weight”: “None”,
            “coef0”: 0.0,
            “degree”: 3,
            “kernel”: “rbf”,
            “gamma”: 0.6,
            “max_iter”: −1,
            “probability”: “True”,
            “random_state”: “None”,
            “shrinking”: “True”,
            “tol”: 0.001,
            “verbose”: “False”
        }
    }
    }
}
```

In some embodiments, in the instance where the golden set includes documents that belong to multiple classes—either the documents have overlapping classes or some documents belong to mutually exclusive classes—it may be optimal to utilize more than one model to best classify all of the data. For example, the golden set may include two sets of documents that are not related to each other very well, such as national news articles about baseball and journal articles about earthquakes and volcanoes around the Pacific ring of fire. It may be the case that more than one model should be utilized to correctly categorize these two sets of topics that exist in the same raw data set. The metrics and evaluation system 220 therefore may test a combination of models and determine that more than one model produces the most accurate classification of the golden set. The combination of models may be run in parallel to one another on each document in the golden set. The output with the highest confidence for each document may be used, or alternatively, outputs from multiple models that have confidence intervals exceeding a certain threshold (e.g., 95% confidence, 67% confidence, etc.) may all be used, indicating that a document may be classified into multiple classes. In some embodiments, chain classifiers may be used, meaning that the output of one classifier is used as an input in a pipeline with the next classifier. Depending on the classification output of the first classifier, the second chained classifier can modify and attach behavior/classification accordingly.

Of note, by storing multiple models in the model repository 215 and testing them to determine which produce accurate classifications of any golden set, the classification system of the present disclosures allows for a stored model to potentially be suitable for multiple subject matters that may not have been originally intended when the model was first generated. The classification system of the present disclosure therefore offers a unique way to evaluate classification models, that does not demand that each model needs to be originally specifically tailored to a client raw data set and their specific needs.

In some embodiments, once the most suitable model(s) for classifying the golden set is determined by the metrics and evaluation system 220, that model or model combination is utilized in the classification engine 225 to classify the raw data 205 in real time, in the online system 260. The online system 260 may receive as input a stream of live raw data, such as social media posts generated during the day, or a collection of research articles being processed in rapid succession. The online system 260 may exist in the network-based system 105 and may receive input through the network 190 from one or more devices, including one or more client devices 120 or 130, in some embodiments.

The classification engine 225 produces classified output 230 that expresses a judgement about each document from the raw data 205. This output 230 may be stored in a dedicated storage somewhere in the network based system 105 for a client requesting the classified output. In some embodiments, the classification system of the present disclosure includes a user interface that allows a client to interact with the classified output 230. The user interface may allow for tenant and domain specific experiences 235 for the purpose of enabling interaction with the classified data set. The client may be able to examine the results and in some cases examine the methods and models used to produce the classified output.

At block 240, the classification system may be configured to record all interactions with the classified output 230 through the user interface, to produce behavior and click signals from users. The user interface may allow for the client to signal whether there are any errors in the classified output 230, or what classifications are correct, for example. As the client examines and interacts with the data, the signals are tabulated and funneled back to the offline system 250 via the metrics and evaluation system 220. The metrics and evaluation system 220 may then be configured to incorporate the feedback to make adjustments to the model that are catered to the needs of the raw data. For example, feedback expressing that some of the results are incorrect may be used to adjust certain facets of the model such that the model can correctly classify similar raw data in the future.

In some embodiments, the classified output 230 may be given to multiple customers. For example, the classification system of the present disclosures may be configured to generally classify incoming Tweets of the day, absent any specific instruction from any particular user or customer. Then, multiple news agencies may be given access to the classified output, each accessing the network 190 on their individual devices 120, 130, etc. Therefore, the feedback of user experiences can be multiplied to provide even more for the metrics and evaluation system 220 to adjust the model(s).

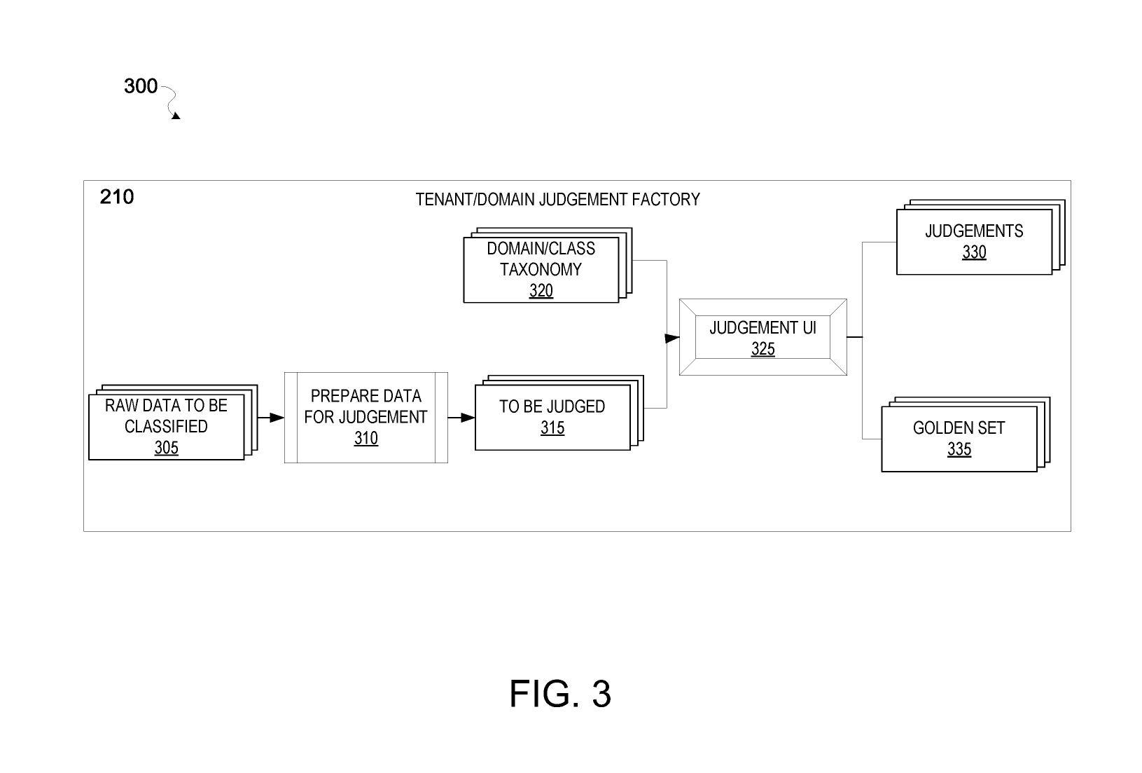

Referring to FIG. 3, illustration 300 provides further details into one example of the tenant and domain judgement factory 210, according to some embodiments. Here, the tenant and domain judgement factory 210 may include one or more processors with memory and is configured to conduct several processes. Starting at block 305, a subset of the raw data to be classified is obtained or ingested through any common I/O interface. The subset of the data is then prepared for judgement at block 310. This may include tokenizing the documents and performing feature extraction, some examples of which are known to those with skill in the art. The output of the preparations at block 310 are staged at block 315, where the documents may now be modified or transformed into blocks of data that are suitable for annotation and judgement. For example, a single document in the subset of raw data may be subdivided into individual sentences or key phrases, based on semantic understanding of the document that was performed during the pre-processing preparations at block 310.

At block 320, a domain or class taxonomy is uploaded or otherwise obtained for use in the classification of the subset of raw data. The taxonomy may be used to represent the set of categories intended for the subset of documents to be classified into. This taxonomy may be supplied by a client, or if the general subject matter is specified, a more generic taxonomy may be supplied by the classification engine itself.

At block 325, the tenant and domain judgement factor 210 may cause display of the documents in a judgement user interface. The user interface may allow for human annotators to classify the documents, or at least portions of the documents, according to a supplied taxonomy from block 320. The tenant and domain judgment factory may be configured to determine what documents or subsets of documents to present in the judgement UI 325 that may efficiently utilize the human annotator's time. For example, the judgement factory 210 may intelligently select only portions of a document it believes it needs to determine how the document should be classified, and provide only that portion in the judgment UI 325, rather than have the human annotator read the entire document. In other cases, certain portions may be highlighted or emphasized. In some cases, one document may be presented multiple times in the judgement UI 325 for multiple annotators, in order to obtain a more reliable classification.

At blocks 330 and 335, the outputs of the annotations are obtained. One of the outputs is the individual judgments 330 themselves, of each of the documents that were judged. In addition, the judgements tied to the documents are included to form the golden set 335. This is used to gauge the fitness of each of the models in model repository 215 to determine which model(s) is best suited to perform classification on the rest of the raw data.

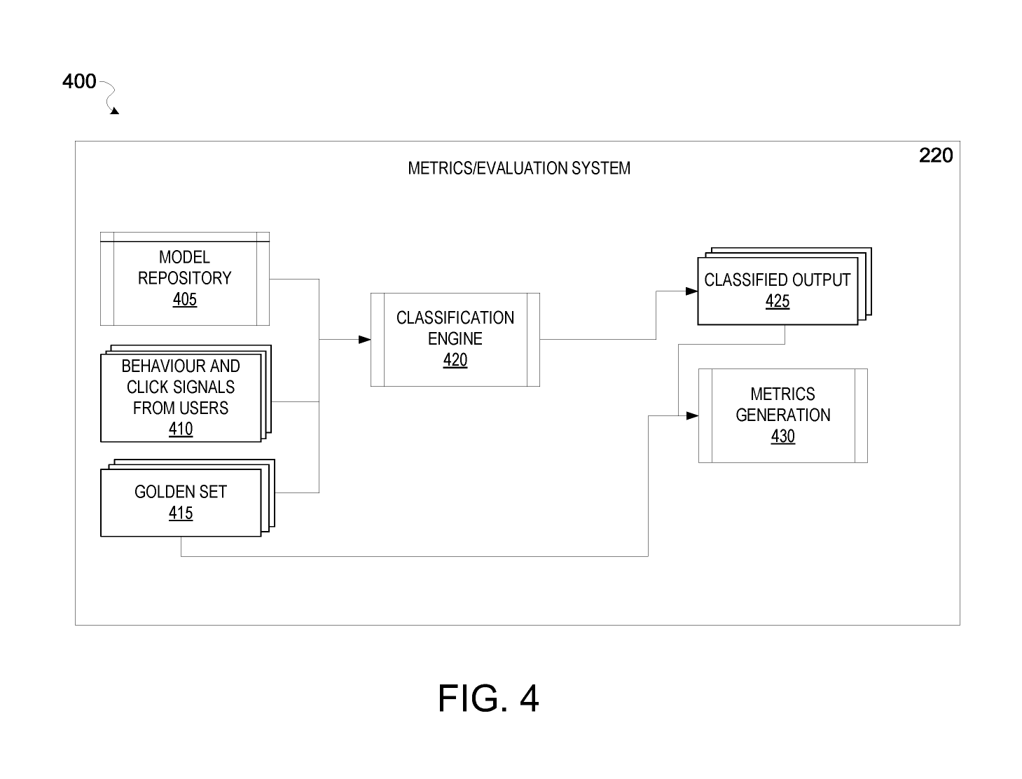

Referring to FIG. 4, illustration 400 provides further details into one example of the metrics and evaluation system 220, according to some embodiments. Here, the metrics and evaluation system 220 gathers inputs from three sources: the model repository 405 (see FIG. 2, block 215), the behaviour and click signals from users 410 (see FIG. 2, block 240), and the golden set (see FIG. 3, block 335). The descriptions for each of these sources are described more above.

At block 420, the metrics and evaluation system 220 utilizes one or more models as an input 405 from the model repository 215, the input of the golden set 415, and in some cases the feedback input 410 provided from the behaviour and click signals from users from a previous iteration of the classification output, and attempts to classify the documents in the golden set using the obtained one or more models in the classification engine 420. If there are inputs from block 410, the classification engine 420 incorporates those while utilizing the current selected model(s). The output is produced at block 425.

Whatever the output is, a metrics generation process occurs at block 430. Example metrics include precision, recall, and F1 scores used to evaluate the models. The results are compared against the golden set 415 and statistics are generated to quantitatively express how close the currently selected model(s) were in classifying the documents in the golden set. This process is repeated for any number of instances for any number of models or combination of models. Each of these iterations is then ranked, and the best performing model(s) according to the ranking are considered for use in classifying the remaining raw data in real time.

Referring to FIG. 5, illustration 500 provides further details into one example of the classification engine 225, according to some embodiments. As stated above, the classification engine 225 is configured to perform real time classification on the raw data using one or more selected classification models that is chosen by the evaluation system 220. To conduct the classification, here, the raw data as an input is first normalized, at block 505. This may include tokenizing each document of the raw data as well as converting all of the textual content of each document into a common format. Formatting may be normalized or even removed. At block 510, feature vector selection is performed on the normalized data. A feature vector contains all the features needed to classify the document/statement. The feature set for selection into the domain classification model may depend on a number of factors, such as:
the number of features available;
the features that are relevant based on the domain experts;
the features that are auto-selected based on feature reduction mechanism; and
thresholding factors that can either make a feature in/out.

In some cases this means, based on the kind of output specified, and the data available, the type of output specified by the client can change what are the features in consideration, and the classification engine learns what features matter for the type of classification done. There are a number of types of feature vector selection that are known to those with skill in the art, and embodiments are not so limited.

At block 515, the model determined by the evaluation system 220 is selected from the model repository 215 to be used in performing the classification. At block 520, the classification engine executes the classification process, using the selected model and performs the classification on the feature vector selections. The outputs are then scored at block 525 in the multimodal scenario, and ranked at block 530 using a ranking algorithm. The top results that are above a threshold are selected as the choice(s) for how the feature vector selections are to be classified according to a specified taxonomy, using the selected model.

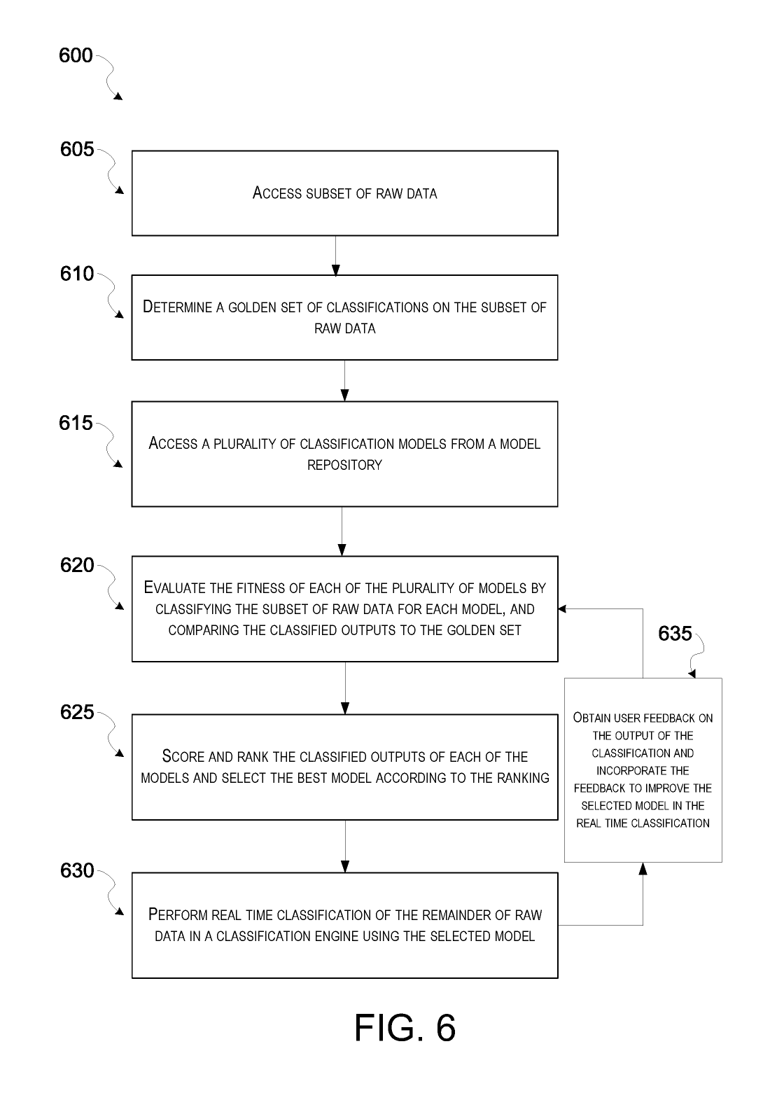

Referring to FIG. 6, flowchart 600 illustrates an example methodology for a classification system to perform a process for classifying a collection of documents in raw data, according to some embodiments. The example methodology may be performed by a classification system as described in FIGS. 1 and 2, for example.

At block 605, the example process starts by a classification system accessing a subset of raw data intended to be classified. An offline system portion of the classification system may be configured to ingest the subset of raw data, consistent with the descriptions in FIG. 2. At block 610, the offline system portion of the classification system may determine a golden set of classified data using the subset of raw data. An example process for determining the golden set is described in FIG. 3. The golden set includes correct classifications of all of the subset of raw data. This golden set may be viewed as a control set or a truth set that classification models are compared against.

At block 615, the classification system may also access a plurality of classification models from a model repository. The offline system portion of the classification system may be configured to retrieve these classification models. Each classification model may be accessed one at a time, and may be used in a test engine to classify the subset of raw data. An example of the model repository is described in FIG. 2.

At block 620, the classification system may then evaluate the fitness or performance of each of the plurality of classification models by classifying the subset of raw data for each model. This may be performed by a metrics and evaluation system as described in FIGS. 2 and 4. Each set of outputs by each of the models may be compared against the true classifications of the subset of raw data as defined by the golden set. The closer the results to the golden set, the more accurate the model is thought to be for handling the remaining raw data.

At block 625, the classification system may quantitatively determine which model is most suitable to classify the remaining amount of raw data by scoring and ranking the classified outputs of each of the models. The scores may be determined based on how closely the output is compared to the golden set. Based on the ranking of the scores, the classification system may select the highest ranking model as the best model for performing the classification on the remainder of the raw data.

In some embodiments, more than one model may be combined together to produce an output of classification that is even more accurate than any single model. In these instances, the combination of models may be used to classify the remaining data.

Thus, at block 630, the classification system may perform real time classification on the remainder of the raw data in a classification engine using the selected model in block 625. This process may be performed in an online system portion of the classification system. The output may be supplied to one or more customers for evaluation and analysis.

In some embodiments, at block 635, the customer may be able to interact with the classified output data, such as through a user interface as described in FIG. 2. Through these interactions, feedback may be generated that includes assessments as to the correctness of the classified output. This feedback may be recorded by the classification system automatically whenever a customer interacts with the output data through the user interface. The feedback may be reprocessed by the offline system portion and incorporated into making adjustments and improvements to the model chosen to classify the raw data in real time. In this way, the existing classification model may be improved upon to better cater to the subject matter in the present raw data.

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine 110 or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 1-4. The instructions 724 may also reside, completely or at least partially, within the main memory 704, within the processor 702 (e.g., within the processor's cache memory), or both, before or during execution thereof by the machine 700. The instructions 724 may also reside in the static memory 706.

Accordingly, the main memory 704 and the processor 702 may be considered machine-readable media 722 (e.g., tangible and non-transitory machine-readable media). The instructions 724 may be transmitted or received over a network 726 via the network interface device 720. For example, the network interface device 720 may communicate the instructions 724 using any one or more transfer protocols (e.g., HTTP). The machine 700 may also represent example means for performing any of the functions described herein, including the processes described in FIGS. 1-4.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database 115, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 722 is non-transitory in that it does not embody a propagating signal. However, labeling the tangible machine-readable medium 722 as “non-transitory” should not be construed to mean that the medium is incapable of movement; the medium should be considered as being transportable from one physical location to another. Additionally, since the machine-readable medium 722 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 726 (e.g., the Internet) and via one or more appropriate interfaces (e.g., an API).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A classification system for classifying documents in real time using natural language processing, the classification system comprising:
at least one processor;
at least one memory communicatively coupled to the processor, the at least one memory storing classification modules comprising:
a tenant and domain judgement factory configured to classify a subset of documents from a present set of documents to be classified, and generate a golden set of documents that represents an accurate classification of the subset of documents;
a model repository configured to store a plurality of classification models, wherein each classification model was generated to originally classify a different set of documents than the present set of documents to be classified;
a metrics and evaluation system configured to evaluate a fitness level of each of the plurality of classification models to the present set of documents to be classified, by classifying the golden set using said each classification model and determining which classification model generates the most accurate classification of the golden set; and
a classification engine configured to perform, in real time, classification on the remaining present set of documents to be classified, using the classification model that generated the most accurate classification of the golden set.

2. The classification system of claim 1, wherein the classification engine is further configured to produce a classified output of the remaining present set of documents comprising judgements about the classification of each of the documents.

3. The classification system of claim 2, further comprising a user interface configured to cause display of the classified output and enable user interaction with the classified output.

4. The classification system of claim 3, wherein the user interface is further configured to enable examination of the accuracy of the classified output by a user.

5. The classification system of claim 4, wherein the user interface is further configured to:
produce behavior signals with the classified output by recording user interactions with the classified output; and
transmit the behavior signals to the metrics and evaluation system.

6. The classification system of claim 5, wherein the metrics and evaluation system is further configured to adjust the most accurate classification model using the received behavior signals to produce an even more accurate classification model for classifying the present documents to be classified.

7. The classification system of claim 1, wherein the metrics and evaluation system evaluates the fitness of each of the plurality of classification models by:
calculating at least one of precision, recall, and F1 statistics to evaluate how well each classification model has classified the golden set;
ranking the at least one of precision, recall, and F1 statistics; and
selecting the best ranked classification model to be used to classify the remaining set of documents in the classification engine.

8. The classification system of claim 1, wherein the metrics and evaluation system is further configured to evaluate the fitness level of a combination of two or more classification models stored in the model repository to the present set of documents to be classified, by classifying the golden set using the combination of two or more classification models and determining the combination of the two or more classification models generates the most accurate classification of the golden set.

9. A method by a classification system for classifying documents in real time using natural language processing, the method comprising:
receiving classifications for a subset of documents from a present set of documents to be classified,
generating a golden set of documents using the received classifications that represents an accurate classification of the subset of documents;
accessing a plurality of classification models from a model repository, wherein each classification model was generated to originally classify a different set of documents than the present set of documents to be classified;
evaluating a fitness level of each of the plurality of classification models to the present set of documents to be classified, by performing classification on the golden set using said each classification model and determining which classification model generates the most accurate classification of the golden set; and
performing, in real time, classification on the remaining present set of documents to be classified, using the classification model that generated the most accurate classification of the golden set.

10. The method of claim 9, further comprising producing a classified output of the remaining present set of documents comprising judgements about the classification of each of the documents.

11. The method of claim 10, further comprising causing display, through a user interface of the classification system, of the classified output and enabling user interaction with the classified output.

12. The method of claim 11, further comprising enabling, in the displayed classified output by the user interface, examination of the accuracy of the classified output by a user.

13. The method of claim 12, further comprising:
producing, by the user interface, behavior signals with the classified output by recording user interactions with the classified output; and
transmitting, by the user interface, the behavior signals to a metrics and evaluation system of the classification system.

14. The method of claim 13, further comprising adjusting, by the metrics and evaluation system, the most accurate classification model using the received behavior signals to produce an even more accurate classification model for classifying the present documents to be classified.

15. The method of claim 9, wherein evaluating the fitness of each of the plurality of classification models comprises:
calculating at least one of precision, recall, and F1 statistics to evaluate how well each classification model has classified the golden set;
ranking the at least one of precision, recall, and F1 statistics; and
selecting the best ranked classification model to be used to classify the remaining set of documents in the classification engine.

16. The method of claim 9, further comprising evaluating the fitness level of a combination of two or more classification models stored in the model repository to the present set of documents to be classified, by classifying the golden set using the combination of two or more classification models and determining the combination of the two or more classification models generates the most accurate classification of the golden set.

17. A non-transitory computer readable medium comprising instructions that, when executed by a processor of a classification system, cause the processor to perform operations comprising:
receiving classifications for a subset of documents from a present set of documents to be classified,
generating a golden set of documents using the received classifications that represents an accurate classification of the subset of documents;
accessing a plurality of classification models from a model repository, wherein each classification model was generated to originally classify a different set of documents than the present set of documents to be classified;
evaluating a fitness level of each of the plurality of classification models to the present set of documents to be classified, by performing classification on the golden set using said each classification model and determining which classification model generates the most accurate classification of the golden set; and
performing, in real time, classification on the remaining present set of documents to be classified, using the classification model that generated the most accurate classification of the golden set.

18. The non-transitory computer readable medium of claim 17, wherein the instructions further comprise producing a classified output of the remaining present set of documents comprising judgements about the classification of each of the documents.

19. The non-transitory computer readable medium of claim 18, wherein the instructions further comprise causing display, through a user interface of the classification system, of the classified output and enabling user interaction with the classified output.

20. The non-transitory computer readable medium of claim 19, wherein the instructions further comprise:
producing behavior signals with the classified output by recording user interactions with the classified output; and
transmitting the behavior signals to a metrics and evaluation system of the classification system.
